(19) United States
(12) Patent Application Publication
(10) Pub. No.: US 2013/0107354 A1
(43) Pub. Date: May 2, 2013

(54) MULTILAYER LIGHT-REFLECTING FILM AND METHOD FOR MANUFACTURING THE SAME

(71) Applicants: JEN-HUAI CHANG, TAOYUAN COUNTY (TW); CHAO-YING LIN, NEW TAIPEI CITY (TW)

(72) Inventors: JEN-HUAI CHANG, TAOYUAN COUNTY (TW); CHAO-YING LIN, NEW TAIPEI CITY (TW)

(73) Assignee: EXTEND OPTRONICS CORP., TAOYUAN COUNTY (TW)

(21) Appl. No.: 13/286,178

(22) Filed: Oct. 31, 2011

(51) Int. Cl. F21V 9/06; B29D 11/00

(52) U.S. Cl. 359/359; 264/1.6

(57) ABSTRACT

Disclosed herein are a multilayer light-reflecting film and a method for manufacturing the same. Main body of the light-reflecting film is the structure with multiple layers made of stacked polymers. The structure includes at least one bi-refringence material layer. In accordance with one of the embodiments, the inner or outer side of the light-reflecting film may be disposed with one or more protective layers and one or more functional films. The functional film is preferably made of the polymer with UV-resistant, scratch-resistant and high-reflection effect materials. In the method for manufacturing the light-reflecting film, a co-extruder is utilized to perform a co-extrusion process. Multiple materials are co-extruded to form a co-polymer. After configuring an output quantity and thickness of the extrudate, the multilayer light-reflecting film is formed.

### BACKGROUND OF THE INVENTION

1. Field of the Invention

The instant disclosure relates to a multilayer light-reflecting film and its manufacturing method, in particular, to a type of lens film combined with multilayer film structure and its production.

2. Description of Related Art

The conventional approach to conduct the lens with multilayer film is based on the respective functionality for each layer. For example, the layers may be featured with water-proof, anti-reflection, consolidated structure, and scratch-resistant. More, dyes may be incorporated into the layers to absorb specific band of light, so as to regulate the transparency of the lens.

U.S. Pat. No. 4,878,748 (App. Date: Mar. 28, 1989) disclosed an ultraviolet radiation and blue light blocking polarizing lens, which is featured to have visibility and safety. Such as the conventional polarizer shown in FIG. 1, the lens 10 is a type of the polarizer which can substantially block the light with parallel polarization and a specific wavelength. In an example, a nano-level light-filtration layer 14 on the surface is used to determine the range of wavelength to be filtered. The whole lens 10 includes a plastic substrate 12 forming body of the lens. The structure of the multilayer film has a polarization layer 16 to block the vulnerable ultraviolet and blue ray. The dyes 18 are further coated upon the surface for absorbing a specific range of the light.

FIG. 2 shows a relationship of the wavelength and transmittance of the filtering coating upon the surface of the lens of the prior art. The curve A describes that an orange dyes is formed to allow a portion of ultraviolet ray in the preceding segment of the wavelength range to transmit. Further, the orange dyes allow a good transmittance in posterior segment of the range of the visual light. The curve B represents the performance provided by the red dyes. However, a certain transmittance is allowed in the ultraviolet range. The posterior range of visual light also provides a good transmittance. Curve C indicates that good transmittance in visual light range is provided as mixing the red and orange dyes, but no ultraviolet transmitted.

Further, U.S. Pat. No. 6,659,608 (App. Date: Dec. 19, 2001) disclosed a polarizer that used for a sunglasses or a ski goggles. This type of glass is made of multilayer film structure composed of a polarization layer and a thermoforming dyeing film. The related lens also includes a colorant for modifying its hue in combination with the polarization layer.

To the method for manufacturing the lens of the above-described art, reference is made to U.S. Pat. No. 6,613,433 (App. Date: Sep. 5, 2001) describing a fabricating method of a polarizer. The method includes steps of adhering a multilayer film to a polarizer, and placing the polarizing plate and the multilayer film into a mold. An in-mold forming is then adopted to inject the material into the mold. An end product of polarizer having the multilayer film and the polarizing plate is integrally formed.

### SUMMARY OF THE INVENTION

A multilayer light-reflecting film in accordance with the present invention is related to a reflective lens film having multilayer film structure. One of the objectives of the claimed film is applicable to making a sunglasses, ski goggles, or hydroscope. The film is with features of polarization and removing dazzling, and suitably used to be combined with other functional films.

In one of the embodiments of the multilayer light-reflecting film, the main body of the multilayer light-reflecting film includes multilayer film structure with multiple stacked polymers. The structure at least includes a bi-refringence material layer. Further, a protective layer and a functional film are also disposed onto the inner side, outer side or one of the sides of the reflecting film.

The mentioned functional films formed on the sides of the multilayer light-reflecting film are the material with features of UV-resistant, scratch-resistant, and high-reflection. The surface of the functional film is plated with a high-reflection film, coated with dyes, or blended with particles.

In one further embodiment, the single or double sides of the multilayer light-reflecting film maybe disposed with a polymeric substrate. The substrate is blended with particles, or with a layer of surface structure.

The embodiment of the method for manufacturing the multilayer light-reflecting film includes a first step of feeding multilayer film material having multiple layers of polymer material and some functional films of the multilayer light-reflecting film, a next step of a co-extruder receiving the materials, and performing a co-extrusion process. The further steps in the method include the combination undergoing cleaning, drying, heating, blending, filtering, and finally controlling the output quantity, thickness, and size of the co-polymer. The final multilayer light-reflecting film is therefore formed.

In the manufacture, a substrate is selectively formed on the surface of the co-polymer. The substrate is combined with the multilayer light-reflecting film by an adhesive step or an in-mold forming process.

The multilayer light-reflecting film after a cutting process may be applicable to a protective lens, such as sunglasses, ski-goggles or a hydroscope, which is applied to a circumstance that requires high anti-reflection.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1 shows a schematic diagram of a conventional polarizer;

FIG. 2 describes a relationship between the wavelength and transmittance of the surface coating of the conventional lens;

FIG. 3 describes the optical paths and the embodiment of the multilayer light-reflecting film in accordance with the present invention;

FIG. 4 is a schematic diagram of the functional films of the multilayer light-reflecting film of an embodiment in accordance with the present invention;

FIG. 5 is one of the embodiments showing the multilayer light-reflecting film in accordance with the present invention;

FIG. 6 schematically shows another embodiment of the multilayer light-reflecting film of the present invention;

FIG. 7 schematically shows one more embodiment of the multilayer light-reflecting film of the present invention;

FIG. 8 schematically shows one of the embodiments of the multilayer light-reflecting film of the present invention;

FIG. 9 schematically shows one further embodiment of the multilayer light-reflecting film of the present invention;

FIG. 10 schematically shows one further embodiment of the multilayer light-reflecting film of the present invention;

FIG. 11 is a flow chart describing a method for manufacturing the multilayer light-reflecting film in one embodiment of the present invention;

FIG. 12 shows a schematic diagram of a co-extruder for fabricating the multilayer light-reflecting film of the present invention;

FIG. 13 is a flow chart describing a method for fabricating the multilayer light-reflecting film in one embodiment of the invention;

FIG. 14 is one further flow chart describing the method for fabricating the multilayer light-reflecting film of the present invention.

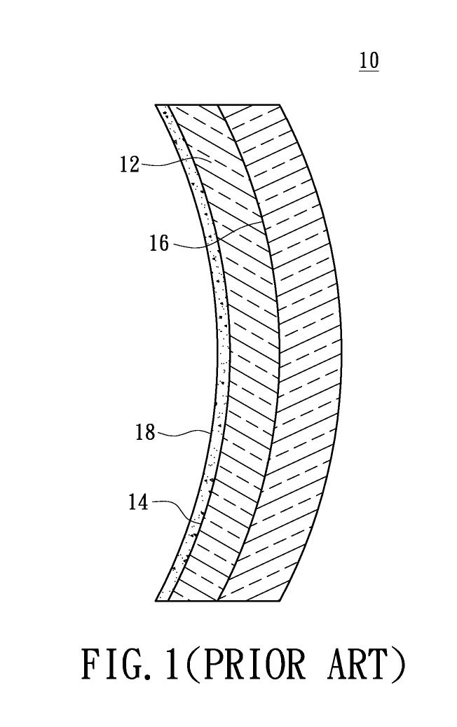

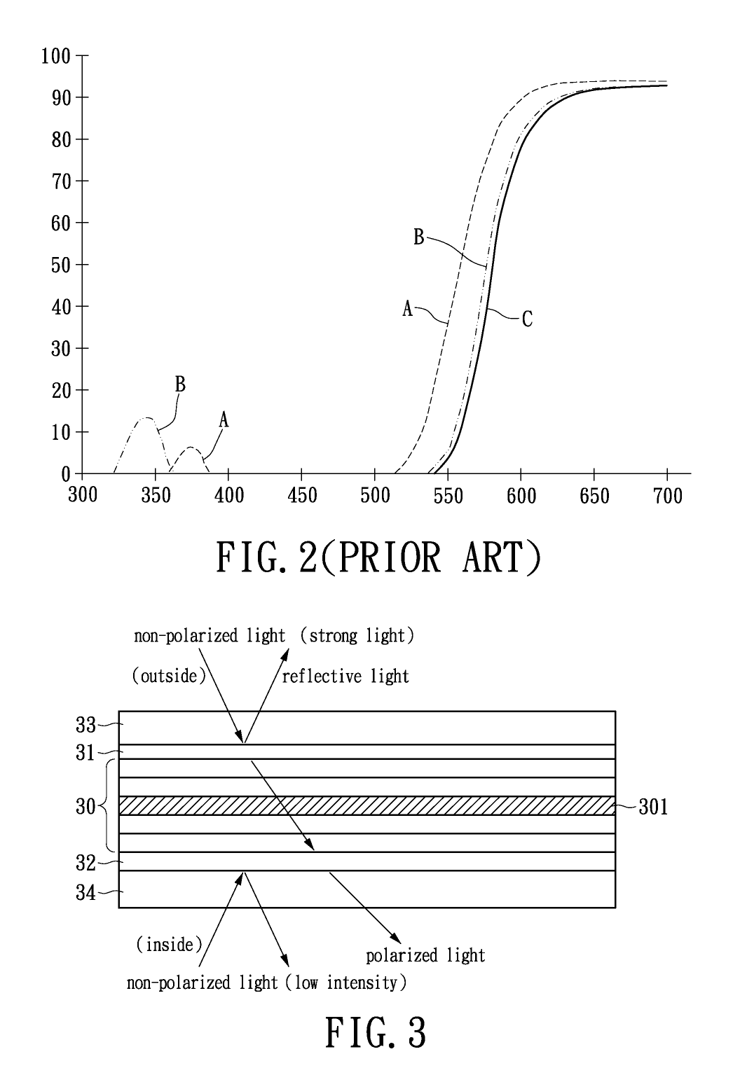

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

A dazzling phenomenon appears resulting in the light emitting to a ground (for example, snow ground) and being reflected from the ground to generate a polarized light, and the polarized light going to human's eyes. For solving the uncomfortable dazzling occurrence, disclosed is a multilayer light-reflecting film according to the embodiment of the invention. The multilayer light-reflecting film is particularly a reflective-type lens film with multilayer film structure, and applicable to the sunglasses, ski-goggles, or hydroscope since it provides the features of polarization and dazzling-elimination. Also, the multilayer light-reflecting film may be adhered to other functional films.

In one of the embodiments, the indexes of reflection of inner and outer sides of the lens film may be configured to be different. The inner layer of the film may be adhered with a polarizer or other functional films, or be treated with anti-reflection. Further, the film may also be an anti-ultraviolet film which is made through a plating process, or formed as a multilayer film (MOF).

Furthermore, a feature of fog-proofing may be introduced through a special process. For example, an additive with function of fog-proofing may be coated upon the lens. The outer surface of the lens may be plated with a hardened protective film, or adhered with a harden material for enhancing the features of anti-attrition and anti-scratch. Further, a color layer can be formed by adhering or plating other materials, or alternatively using a multilayer film. An UV-resistant film is also introduced.

The multilayer light-reflecting film in the present disclosure may not add any special ingredient to absorb a specific band of light, but to conduct an anti-ultraviolet effect with light interference. In the meantime, only visual light can be transmitted. The multilayer film or dyes may be the materials to form the color lens.

The multilayer light-reflecting film is made in combination with the multilayer film structure and the various functional films, and it advantages the reflecting film to eliminate dazzling light from the reflected light by tuning the material ingredient and thickness of the materials. Furthermore, the amount of heat may not be piled up since the reflecting polarizer is not an absorption type. In one exemplary embodiment, the multilayer light-reflecting film has high polarizing efficiency and strong function of elimination of dazzling without any absorptive particle added. Furthermore, anti-reflection feature may be incorporated with additives of particles into the substrate or functional film.

Reference is made to FIG. 3 showing an embodiment of the multilayer light-reflecting film and its optical path in accordance with the present invention.

One of the embodiments of the multilayer light-reflecting film introduces multilayer film structure 30 formed by combining multiple layers of polymer materials to be the body of the film. The multilayer light-reflecting film includes one or more protective layers (31, 32) formed between the multilayer film structure 30 and the functional films (33, 34), or outside of the structure of the fabrication of the multilayer film structure 30 and the functional films. In the present example, a first protective layer 31 and a second protective layer 32 are formed at inside, outside or one of the sides of the multilayer film structure 30. A first functional film 33 and a second functional film 34 are respectively formed at the two sides outside the each protective layer.

The protective layer may be the molecule polymer material which is able to filter ultraviolet. The dyes are used to filter a portion of visual light. In the meantime, an incident light may be a polarized light. The present embodiment of the multilayer light-reflecting film shows its outside is the side close to the external strong light such as the sunlight with both polarized light and non-polarized light. After the non-polarized light enters the first functional film 33, the light is reflected by the first protective layer 31 which is formed by the molecule polymer material with function of filtering ultraviolet. The light then enters the body of the multilayer film structure 30, and penetrates to be a polarized light.

The inside of the multilayer light-reflecting film is close to the human eyes or indoor. The inside includes low-intensity non-polarized light reaches the multilayer light-reflecting film, and the non-polarized light passes through a second functional film 34. The emitted light is reflected by a second protective layer 32 formed of the molecule polymer material with function of filtering ultraviolet.

Reference is made to FIG. 3 showing the embodiment of the multilayer light-reflecting film. The shown multilayer film structure 30 is formed by inter-stacking a plurality of molecule polymers. At least one bi-refringence material layer 301 is included. The position of the bi-refringence material layer 301 within the multilayer film structure 30 is not limited to the diagram. The multilayer light-reflecting film in accordance with the present invention is configured to have both anti-ultraviolet and polarization.

The bi-refringence material layer 301 is exemplarily formed by multiple layers of polyester material. A stretching process is introduced to performing uniaxial or biaxial stretching onto the material. A predetermined difference of refractive index along at least one direction is formed among the polyester optical layers. The bi-refringence material layer 301 is featured with different refractive indexes along two directions (X, Y) on a plane. Or, it is featured that the plane (X, Y) and the Z direction of the bi-refringence material layer 301 have different refractive indexes.

The external portion (outside or inside) of the multilayer film structure 30 is to form one or more protective layers, such as the first protective layer 31 and the second protective layer 32. The protective layer may be formed of the molecule polymer material with function of filtering ultraviolet.

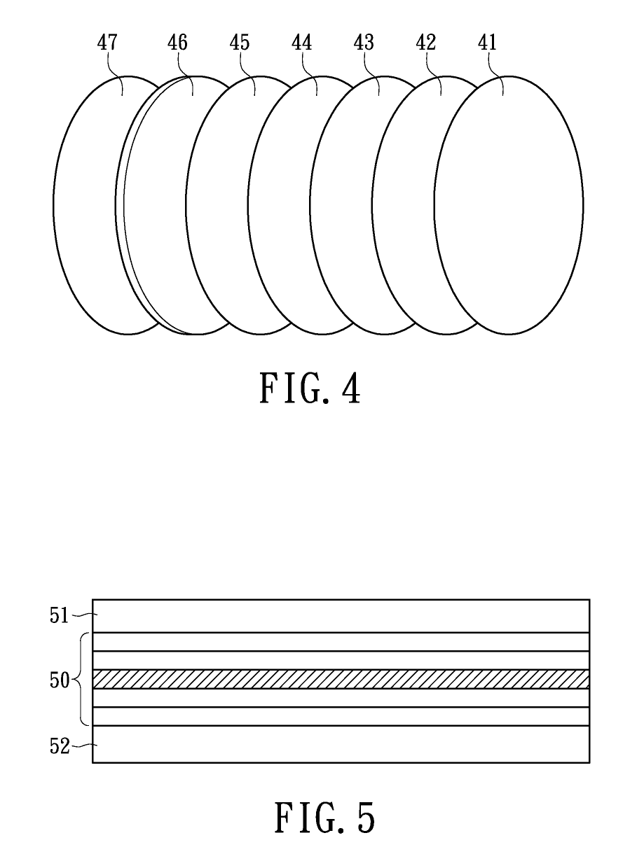

The mentioned functional films may be selectively formed at the inside, outside or one of the sides of the multilayer film structure 30. In the present embodiment, the described first functional film 33 and the second functional film 34 are formed on the inner or outer surfaces of the multilayer film structure 3. One of the applications of the functional film is shown on FIG. 4. Both the first functional film 33 and the second functional film 34 include a plurality of inter-stacked molecule polymer layers. The materials exemplarily form a combination of a waterproof layer 41, an anti-reflective layer 42, a strengthening layer 43, a bonding layer 44, scratch-resistant layers (45, 47), impact-resistant optical-grade PC safety lens 46, and the like.

The waterproof layer 41 keeps the lens from water since it does not easily soak the water and easier to be cleared. The anti-reflective layer 42 is with multilayer film structure that effectively allows the light to reach the retina, so the image is much clearer. The strengthening layer 43 is used to harden the lens for impact resistant. The bonding layer 44 serves the multilayer film (for example, Titanium/silicon crystal) to firmly adhere the functional film and the lens. The first scratch-resistant layer 45 is disposed in front of the lens 46, and a permanent silicon-based layer is coated on the surface. The second scratch-resistant layer 47 is disposed in the rear of the lens 46, and also the permanent silicon-based layer is coated thereon.

The selections of those functional films and in combination with the multiple layers exemplarily allow the first functional film 33 to be the molecule polymer material featuring UV-resistant, scratch-resistant, and high-reflection. Further, the additive, such as metal oxide, of heat-insulation particles for high-visibility infrared ray (ATO) or ultraviolet absorber may be introduced. The second functional film 34 is formed of the molecule polymer material with function of filtering ultraviolet. A high-reflection film may be plated onto the surface of the first functional film 33 or the second functional film 34. Alternatively, a layer of dyes may be coated on the surface of the film. Further, a co-extrusion process may be introduced to blending particles into the first functional film 33 or the second functional film 34. In the case, the particles are the metal oxide materials with high-visibility infrared ray ATO, or ultraviolet absorber.

The following FIGS. 5 through 10 describe the various embodiments of the multilayer light-reflecting film according to the present invention.

FIG. 5 shows a basic type of the multilayer light-reflecting film, in which pluralities of stacked molecule polymers form the multilayer film structure 50. The sectional lines indicate the bi-refringence material layer. The two sides of the multilayer film structure 50 are the first functional film 51 and second functional film 52, for instance.

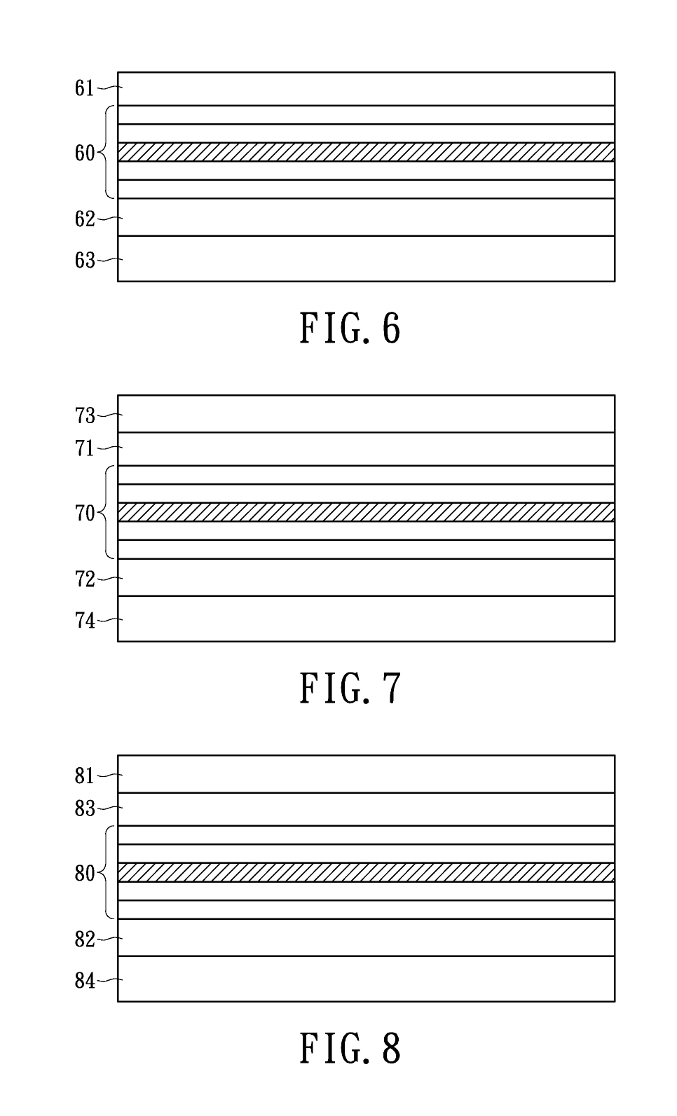

FIG. 6 schematically shows the body of the multilayer light-reflecting film being a multilayer film structure 60. The structure 60 is also formed of the inter-stacked molecule polymer layers. The sectional lines indicative of a bi-refringence material layer is formed. The inner or outer side of the multilayer film structure 60 forms the first functional film 61 or the second functional film 62. In the present example, one side of the second functional film 62 is adhered with a substrate 63.

FIG. 7 shows a schematic diagram of the multilayer light-reflecting film in one embodiment of the present invention. The multilayer light-reflecting film includes a multilayer film structure 70 having at least one bi-refringence material layer indicated by the region drawn by the sectional lines. Two sides of the multilayer film structure 70 are a first functional film 71 and a second functional film 72 respectively. The present embodiment, rather than the example in FIG. 6, provides two substrates respectively formed at two sides of the structure 70, such as a first substrate 73 and a second substrate 74 formed outside the functional film.

One further embodiment of the multilayer light-reflecting film is as shown in FIG. 8. The present multilayer light-reflecting film includes multilayer film structure 80 having at least one bi-refringence material layer shown as sectional lines. Rather than the embodiment shown in FIG. 7, the substrate and the functional film in the present example are formed in an altering combination. One side of the shown multilayer film structure 80 (upper portion of the diagram) forms a first substrate 83, and the other side thereof forms a second functional film 82. More, a first functional film 81 is formed at an outer side of the first substrate 83, and a second substrate 84 is formed at one side of the second functional film 82.

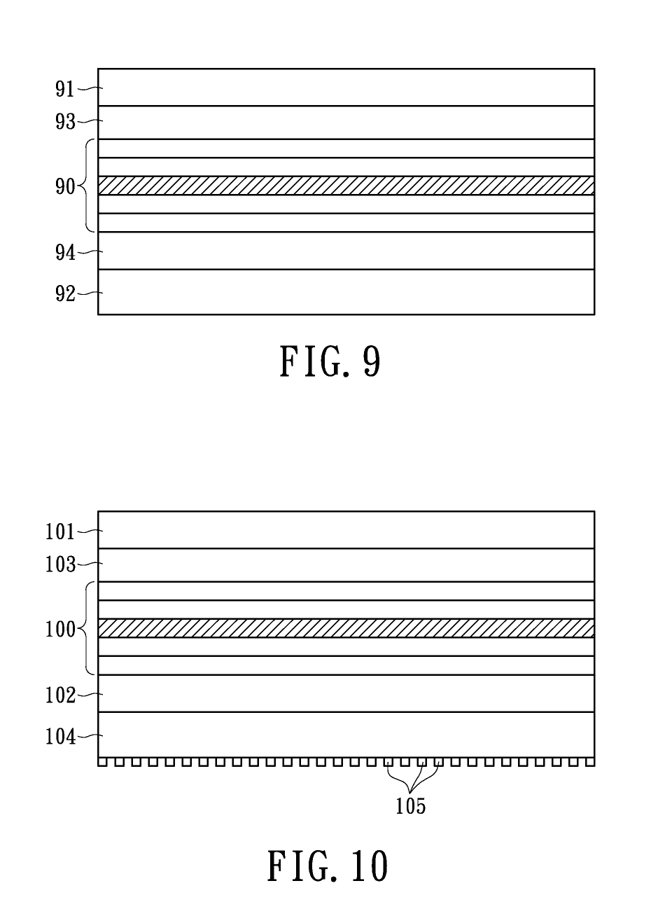

Next, FIG. 9 shows one further embodiment of the multilayer light-reflecting film in accordance with the present invention. The body of the multilayer light-reflecting film is shown as multilayer film structure 90. Rather than the structure shown in FIG. 7, the arrangement of the present example is different since two sides of the multilayer film structure 90 are respectively a first substrate 93 and a second substrate 94. Still further, a first functional film 91 is formed outside the first substrate 93, and a second functional film 92 is formed outside the second substrate 94.

FIG. 10 also shows another embodiment of the multilayer light-reflecting film in accordance with the present invention. A multilayer film structure 100 is the body of the multilayer light-reflecting film, and the sectional lines indicate that the structure 100 has at least one bi-refringence material layer with function of polarization or the similar functional structure. The two sides of the multilayer film structure 100 are respectively disposed with a first substrate 103 and a second functional film 102. A first functional film 101 is disposed outside the first substrate 103, and a second substrate 104 is onto the other side of the second functional film 102. The present embodiment, rather than the above described examples, shows surface structure 105 formed outside the second substrate 104. The surface structure 105 is defined in accordance with the textures made on the mold or rolls in the process. The surface structure 105 enhances the reflectivity of the multilayer light-reflecting film.

The surface structure of the substrate may be configured to have the functions of scratch-resistant, impact-resistant, anti-ultraviolet, fog proofing through a certain surface treatment, for example under a fog-proofing treatment. A protective lens may be therefore made by installing the multilayer light-reflecting film onto a lens holder. The outer surface of the lens may be processed by a hardening treatment, for example by a vacuum coating process. The surface treatment serves the lens to have better impact resistance and wear resistance. Further, the lens may be functioned to resist external impact, scratch, and vulnerable ultraviolet through a film-plating process.

Based on the above-described embodiments, the multilayer light-reflecting film in accordance with the present invention is disposed with one or more substrates onto its single or double sides. The substrate material may be blended with particles in some embodiments. It is noting that the above arrangements of the layers may not be used to limit the present invention.

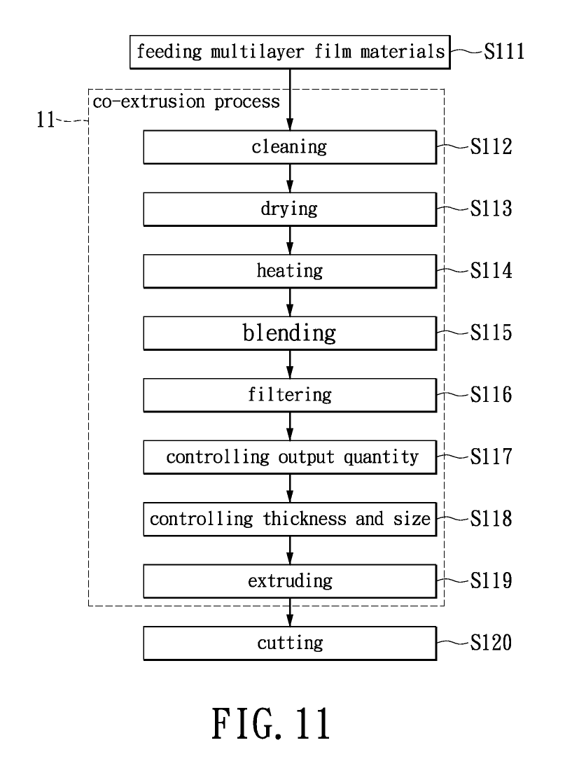

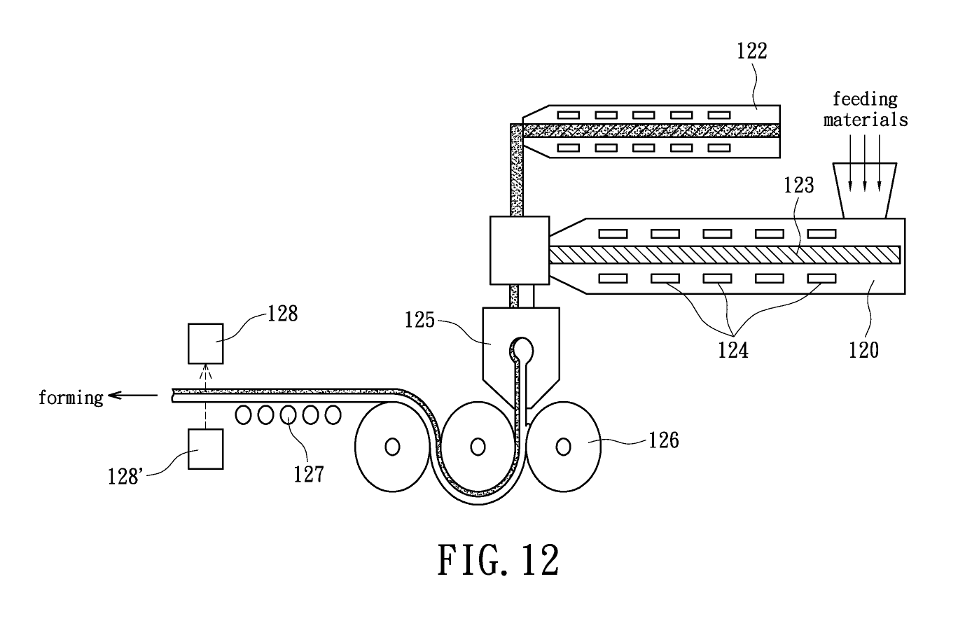

The way to manufacture the multilayer light-reflecting film according to the instant disclosure is referred to the flow chart of FIG. 11. The present example incorporates a co-extrusion system disclosed in FIG. 12. After feeding various materials, a co-extrusion process is used to extrude two more molecule polymer materials which are staggered and stacked, so as to form the multilayer film structure. In the beginning, such as step S111, the system is fed with the materials for fabricating the multilayer film. The materials include multiple layers of molecule polymer materials and one or more functional film materials. For a certain requirement, one or more kinds of materials for fabricating the protective layer are selectively included. The descriptions of the above embodiments show the selections of the feeding materials determine the types for the manufacture of multilayer light-reflecting film.

The feeding matter may be referred to the description of FIG. 12, which shows a schematic diagram of a co-extruder for manufacturing the multilayer light-reflecting film.

Firstly, the materials related to the multilayer film (including substrate) are injected into a primary feeding zone 120 or a secondary feeding zone 122. In an exemplary example, the materials may include the materials for building the protective layer or/and functional films for the multilayer film. The molecule polymer materials for the multiple layers, such as the claimed multilayer light-reflecting film, and one or more layers of the functional film or protective layer are exemplarily included. The materials for building the substrate and the multiple layers are mostly the thermoplastic molecule polymers, such as co-polymer or at least one selected from Poly(Methyl methacrylate) (PMMA), Polycarbonate (PC), (Methyl methacrylate)Styrene (MS), and PolyStyrene (PS), Poly(Ethylene Terephthalate) (PET), Poly(Ethylene Naphthalate) (PEN), and Polypropylene (PP). However, those materials may not limit the present invention.

After feeding material into the primary feeding zone 120 and secondary feeding zone 122, the materials are push forward by a feeding screw 123. Next, a co-extrusion process such as shown in FIG. 11) is performed. To begin the process, the method is to conduct dust-removal and cleaning for the multilayer film (including substrate) materials (step S112). Next, the material undergoes a drying process (step S113) prepared for the blending and mastication processes. The blended Polymeric materials usually require a heater 124 for heating the materials to be melting state (step S114). It should be noticed that a shear-cutting effect may be produced in the blending process and generate high temperature. The high temperature may cause material decomposition. Therefore, some processing agents or modification agents may be suitably added in the blend process for improving the mechanical or thermal properties of the materials (step S115).

After heating and blending the materials, the various feeding multilayer film materials form a co-polymer. The blending may employ a Hunschel Mixer, Ribbon Mixer or barrel mixer to fully mix the materials. A mastication machine is used to gelatinize the polymeric materials. The impurities of the co-polymer can be filtered by a net after the blending and masticating processes (step S116). Next, a gear wheel set is used to control an output quantity of the materials (step S117). The thickness and size of the output is also controlled (step S118). Furthermore, the feeding flow channel can be configured to control the thickness of each material or diffusion sheet through the co-extrusion process.

After that, the melting molecule polymer materials are processed by a splitting unit to form multiple layers and under a continuous co-extrusion via a die 125 (step S119). In which, the die 125, such as a T-die, is functioned to uniform the extruding temperature and thickness of the materials. The die 125 effectively controls the output quantity, and the thickness and size of the films. The thickness of films is controlled by adjusting gap of roll 126 and the output quantity of the extruder. It is featured that a certain required thickness of the materials can be acquired through the die 125, and the roll 126 is used to adjust the thickness of the substrate.

In an exemplary embodiment, surface structure is formed upon one surface or upper/lower surface of the extrudate by a molding process. A cooling process is used to cure the materials, preferably by a cooling platform 127.

The cooling process serves a low temperature to cool down the materials within a cooling zone. The cooling time costs one to five seconds under a temperature between 60 degrees centigrade and 120 degrees centigrade. A heating treatment is processed thereto after the one to five seconds cooling. The multilayer light-reflecting film preferably has formability through extrusion processed onto the multilayer light-reflecting film. Examination devices 128, 128′ are finally used to examine the property of the reflecting film.

If the multilayer light-reflecting film passes the examination, such as step S120, the film may be installed into a specific device after a cutting process, such as into a lens holder for making a protective lens.

The co-extruder shown in FIG. 12 performs the co-extrusion process. A bi-refringence material layer may be selectively formed in the multilayer light-reflecting film through the extrusion process. The multiple polyester materials within the multilayer film undergo a uniaxial or biaxial stretching process. The optical film with the polyester materials may form the effects of divergent refractive indexes along the various directions within the film. Therefore, the bi-refringence material layer is featured with different refractive indexes along two directions on a plane (X, Y). Furthermore, a vertical Z-direction also has different refractive index.

Furthermore, the biaxial stretching process is performed on the bi-refringence material layer material. The biaxial stretching process may be performed by gradually “machine-direction (MD)” stretching or “transverse-direction (TD)” stretching for several times. By biaxial MD and TD stretching for times, the stretched film layers may have various refractive index differences.

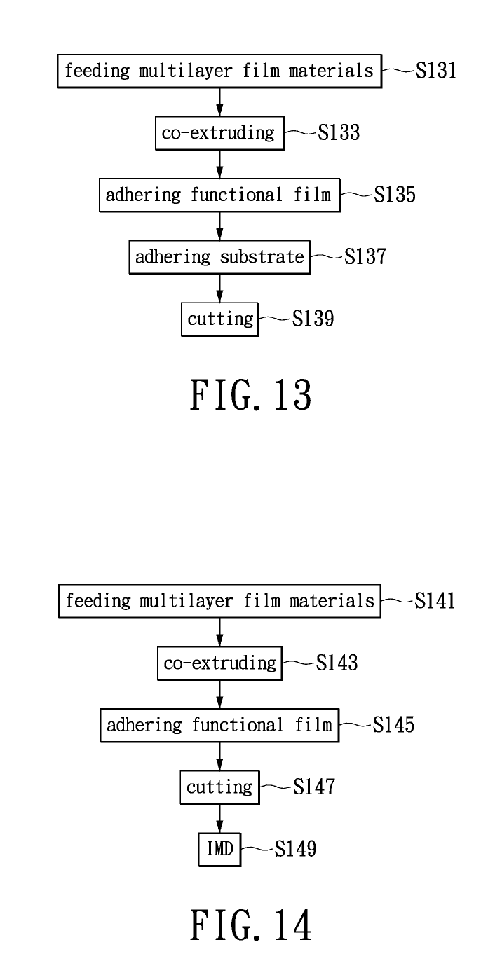

FIG. 13 describes a flow chart of manufacturing the multilayer light-reflecting film in accordance with the present invention. The beginning step S131 shows feeding the multiplayer film materials into a feeding port of the co-extruder. The materials of the multilayer film may include the material for building the protective layer, or others as required. The further steps, including cleaning, drying, heating, blending, impurities filtering, output quantity controlling, thickness and size controlling, are also included in the co-extrusion process (step S133). The end multilayer light-reflecting film is formed.

The further step S135 shows the one or more functional films are formed outside or inside the multilayer light-reflecting film. The combination is able to provide one or more functions selected from waterproofing, anti-reflection, fog-proofing, scratch-resistant, and to harden the structure. A substrate may be selectively adhered with the multilayer light-reflecting film and the functional film (step S137). The substrate may improve the film's anti-reflection ability by adding particles. Surface structure may also be formed on the substrate by molding or roll-molding process. The textured surface may be functioned to be scratch-resistant, impact-resistant, anti-ultraviolet, or/and fog-proofing. A cutting step is then performed onto the extrudate as required (step S139)

In FIG. 14, another method for manufacturing the multilayer light-reflecting film is described.

Such as step S141, the method is to feed materials into the feeding port of the co-extruder. Next, such as step S143, a co-extrusion process is performed to form an initial state of co-polymer for the multilayer light-reflecting film. Rather than the flow described in FIG. 13, an in-mold decoration/forming (IMD) process is introduced in the present embodiment as adhering to the functional film (step S145). It is required that a specific size of the co-polymer and the protective film should be firstly defined according to the requirement before the IMD process (step S147). In step S149, the IMD process is used to combine the materials of substrate and the co-polymer made by the co-extrusion process.

In the process of in-mold decoration/forming, the co-polymer can be combined with the substrate material, functional film material, and the protective layer material within a mold. The molding method is to combine the substrate material and the co-polymer in one piece. An end product is therefore formed by an injection molding method.

In summation of the above description, the present invention is related to a multilayer light-reflecting film having a body with multilayer film structure. The film is with effect of polarization, and also operated with the various functional films. The end product is featured to be with UV-resistant, scratch-resistant, or/and high-reflection.

It is intended that the specification and depicted embodiment be considered exemplary only, with a true scope and spirit of the invention being indicated by the broad meaning of the following claims.

What is claimed is:

1. A multilayer light-reflecting film, comprising:
a plurality of polymers stacked to form multilayer film structure, in which the multilayer film structure includes at least one bi-refringence material layer; and
one or more functional films, combined with inside or/and outside, or one of the sides of the multilayer film structure.

2. The multilayer light-reflecting film of claim 1, wherein the multilayer light-reflecting film includes one or more protective layers formed between the multilayer film structure and the one or more functional films, or outside the structure formed of the multilayer film structure and the one or more functional films.

3. The multilayer light-reflecting film of claim 2, wherein the protective layer is formed of the polymer with function of filtering ultraviolet.

4. The multilayer light-reflecting film of claim 1, wherein the functional film includes a first functional film and a second functional film, respectively formed onto two sides of the multilayer film structure.

5. The multilayer light-reflecting film of claim 4, wherein the first functional film is the polymer with features of UV-resistant, scratch-resistant, and high-reflection.

6. The multilayer light-reflecting film of claim 5, wherein surface of the first functional film is plated with a high-reflection film.

7. The multilayer light-reflecting film of claim 5, wherein surface of the first functional film is coated with dyes.

8. The multilayer light-reflecting film of claim 5, wherein the material of first functional film is blended with particles.

9. The multilayer light-reflecting film of claim 4, wherein the second functional film is formed of the polymer with features of filtering ultraviolet and anti-reflective.

10. The multilayer light-reflecting film of claim 9, wherein surface of the second functional film is plated with a high-reflection film.

11. The multilayer light-reflecting film of claim 9, wherein surface of the second functional film is coated with dyes.

12. The multilayer light-reflecting film of claim 9, wherein the material of second functional film is blended with particles.

13. The multilayer light-reflecting film of claim 12, wherein the particles is material of metal oxide capable of reflecting infrared ray.

14. The multilayer light-reflecting film of claim 1, wherein the single side of double sides of the multilayer light-reflecting film is disposed with one or more substrates.

15. The multilayer light-reflecting film of claim 14, wherein material of the substrate is blended with particles.

16. The multilayer light-reflecting film of claim 14, wherein the substrate has surface structure.

17. The multilayer light-reflecting film of claim 1, wherein the bi-refringence material layer is featured with different refractive indexes along two directions on a plane.

18. A protective lens adopting the multilayer light-reflecting film as claimed in claim 1.

19. A method for manufacturing a multilayer light-reflecting film, comprising:
feeding material of multiplayer film using a co-extruder, wherein the material of multilayer film includes multilayer polymer material, and material of one or more multilayer functional film of the multilayer light-reflecting film;
the co-extruder receiving the fed multilayer film material, and performing a co-extrusion process, comprising:
cleaning and drying the multilayer film material;
heating and blending the multilayer film materials from different feeding ports, and forming a co-polymer;
filtering impurities of the co-polymer;
controlling an output quantity of the co-polymer;
controlling thickness and size of the co-polymer; and
extruding to form the multilayer light-reflecting film.

20. The method of claim 19, further comprising material of one or more protective layers.

21. The method of claim 20, wherein the protective layer material is polymer with feature of filtering ultraviolet.

22. The method of claim 19, wherein, the formed multilayer light-reflecting film is combined with a lens holder after a cutting process.

23. The method of claim 19, wherein the functional film material is polymer with features of UV-resistant, scratch-resistant, and high-reflection.

24. The method of claim 23, wherein surface of the functional film is plated with a high-reflection film.

25. The method of claim 23, wherein surface of the functional film is coated with dyes.

26. The method of claim 23, wherein material of the functional film is blended with particles.

27. The method of claim 26, wherein the particles are metal oxide material with feature of reflecting infrared ray.

28. The method of claim 19, wherein the fed material includes a substrate material, which is combined with the co-polymer through the co-extrusion process.

29. The method of claim 28, wherein the substrate material is blended with particles through the co-extrusion process.

30. The method of claim 28, wherein the co-extrusion process includes an extruding process using a mold or rolls of the co-extruder, and forming surface structure onto surface of the substrate material.

31. The method of claim 19, wherein the fed material includes material for forming a bi-refringence material layer.

32. The method of claim 31, wherein the bi-refringence material layer undergoes a stretching process for stretching the bi-refringence material with uniaxial or biaxial stretching, so as to form the bi-refringence material layer within the multilayer light-reflecting film.

33. The method of claim 32, wherein the bi-refringence material layer is featured with two different refractive indexes along two directions on a plane.

34. A method for manufacturing a multilayer light-reflecting film, comprising:
feeding a multilayer film material including multiplayer polymer material, and one or more materials of functional layers of the multilayer light-reflecting film;
a co-extruder receiving the fed materials of the multilayer film, and performing a co-extrusion process, comprising:
cleaning and drying the multilayer film materials;
heating and blending the multilayer film materials, and forming a co-polymer;
filtering impurities of the co-polymer;
controlling an output quantity of the co-polymer;
controlling thickness and size of the co-polymer;
extruding the co-polymer;
adhering a substrate with surface of the co-polymer, and forming the multilayer light-reflecting film.

35. The method of claim 34, wherein the multilayer film material further includes one or more materials of the multilayer protective layer.

36. The method of claim 35, wherein the protective layer material is polymer with function of filtering ultraviolet.

37. The method of claim 34, wherein the substrate and the co-polymer are combined in an in-mold forming process.

38. The method of claim 34, wherein the multilayer light-reflecting film is combined with a lens holder after a cutting process.

39. The method of claim 34, wherein the functional film material is the polymer with features of UV-resistant, scratch-resistant, and high-reflection.

40. The method of claim 39, wherein surface of the functional film is plated with a high-reflection film.

41. The method of claim 39, wherein surface of the functional film is coated with dyes.

42. The method of claim 39, wherein the functional film material is blended with particles.

43. The method of claim 42, wherein the particles are the material of metal oxide capable of reflecting infrared ray.

44. The method of claim 34, wherein the substrate material is added with particles.

45. The method of claim 34, wherein surface structure is formed on the substrate surface by an extruding process using a mold or rolls.

46. The method of claim 34, wherein the fed material includes material of a bi-refringence material layer.

47. The method of claim 46, wherein the bi-refringence material layer material undergoes a stretching process with a uniaxial or biaxial stretching, and forms a bi-refringence material layer within the multilayer light-reflecting film.

48. The method of claim 47, wherein the bi-refringence material layer is featured with different refractive indexes along two directions on a plane
